(19) United States
(12) Patent Application Publication
(10) Pub. No.: US 2003/0150571 A1
(43) Pub. Date: Aug. 14, 2003

(54) Method of deacidifying cellulose-based materials

(76) Inventors: Raymond H. Thomas, Niagara Falls, NY (US); David L. Diggs, Westfield, NJ (US)

Correspondence Address: Synnestvedt & Lechner LLP, 2600 Aramark Tower, 1101 Market Street, Philadelphia, PA, 19107-2950, US

(21) Appl. No.: 10/299,474

(22) Filed: Nov. 18, 2002

Related U.S. Application Data
(60) Provisional application No. 60/346,759, filed on Nov. 16, 2001.

(51) Int. Cl. B05D 1/18; C08L 1/00; C09K 3/00

(52) U.S. Cl. 162/72; 427/430.1; 106/201.1; 536/101; 162/74; 252/182.11; 252/182.33

(57) ABSTRACT

Provided are methods of deacidifying a cellulose-based material by providing a deacidification composition comprising a hydrofluorocarbon and a deacidification agent dispersed within the hydrofluorocarbon, and contacting the cellulose-based material with the composition to increase the pH associated with the cellulose-based material. Also provided are deacidification compositions for use in the present methods.

### CROSS-REFERENCE TO RELATED APPLICATION

This application claims priority to U.S. Provisional Application No. 60/346,759 which was filed with the United States Patent and Trademark Office on Nov. 16, 2001.

### FIELD OF INVENTION

The present invention relates generally to the deacidification of cellulose-based materials. In particular, the present invention relates to the use of hydrofluorocarbon-based fluids to reduce the acidity associated with cellulose-based materials.

### BACKGROUND OF THE INVENTION

The deterioration of paper, books, newspaper, and other cellulose-based materials is a problem of growing concern throughout the world. It has been estimated, for example, that of the approximately 20 million books in the collection of the Library of Congress, about 30% are in such a state of deterioration that they cannot be circulated. At the New York Library, it was discovered that nearly half of the more than five million books housed therein are subject to severe deterioration. In addition, it is estimated that 97% of all the books published between 1900 and 1949 have a useful life of no more than about 50 years.

A major cause associated with the deterioration of cellulose-based materials is the inherent acidity of such materials. The manufacture of paper and other cellulose materials often requires the addition of acids and acidic chemicals to the materials to reduce absorbency and to allow the paper products to accept inks and dyes. In addition, the manufacturing processes of these materials often include the introduction of additives via acidic mechanisms. Unfortunately, such manufacturing processes often result in cellulose-based products having residual acidic material associated therewith. The cellulose-based products tend to have low pHs and accordingly, tend to undergo slow, but relentless, acid deterioration.

One suggested method for slowing the deterioration of acidic cellulosic materials is disclosed in U.S. Pat. No. 4,522,843, issued to Kundrot which is incorporated herein by reference. Kundrot describes a method of raising the pH associated with a cellulose product by dispersing a basic metal salt into a chlorofluorocarbon fluid, such as, trichloromonofluoromethane, trichlorotrifluoroethane, dichlorotetrafluoroethane, and mixtures thereof, to form a deacidification medium, and treating the cellulose product with the deacidification medium to reduce the acidity of the cellulose product.

Another suggested method for lowering the acidity of cellulose materials is the Wei T'o process disclosed in a 1988 report from the U.S. Office of Technology Assessment (U.S. Congress, Office of Technology Assessment, Book Preservation Technologies, OTA-0-375, DC: U.S. Government Printing Office, May 1988), incorporated in its entirety herein by reference. The Wei T'o process uses a solution of magnesium methyl carbonate dissolved in methanol mixed with chlorofluorocarbons to effect deacidification of cellulose materials.

Unfortunately, chlorofluorocarbons, including those listed for use in the Kundrot and Wei T'o processes, are suspected of contributing significantly to the deterioration of the earth's ozone layer and most have been banned from use in industrial, commercial and other applications. Accordingly, applicants have come to appreciate the need for a new method of deacidifying cellulose products that does not require the use of chlorofluorocarbons.

In particular, applicants have recognized that new deacidification methods allowing for the introduction of basic particles to cellulose materials would be beneficial. However, in formulating such methods, it is often difficult to predict whether basic particles will be sufficiently dispersable in any given medium to allow for deacidification. That is, for a delivery medium to be effective in introducing basic particles to a substrate, it is generally necessary for the medium to hold a certain minimum amount of particles dispersed therein over a given period time. Such dispersion properties are often not readily apparent from the dispersion properties of prior art compositions.

Moreover, non-chlorofluorocarbon fluids which have heretofore been used for dispersing basic metal particles therein tend to be expensive and/or tend to have high boiling points, thus requiring extra heat, time and equipment to remove them from cellulose materials after deacidification. For example, U.S. Pat. No. 5,409,736, incorporated herein by reference, discloses the use of perfluoromorpholine and/or perfluoropolyoxyether as a medium in which to disperse basic metals salts. However, such fluids tend to be relatively expensive, often costing as high as $40/lb. or higher. Moreover, perfluorinated compounds have been identified as contributors to global warming problems and are disfavored for this additional reason.

U.S. Pat. No. 6,080,448, incorporated herein by reference, discloses the use of hydrofluoroethers which, not only tend to be expensive, but also tend to have undesirably high boiling points.

Accordingly, applicants have recognized the need for new methods of deacidifying cellulosic materials which overcome the disadvantages associated with prior art processes.

### BRIEF DESCRIPTION OF THE DRAWINGS

FIG. 1 is a graphical depiction of dispersion data associated with two compositions according to certain embodiments of the present invention.

FIG. 2 is a graphical depiction of dispersion data associated with three compositions according to certain embodiments of the present invention and one comparative composition.

### DESCRIPTION OF THE INVENTION AND PREFERRED EMBODIMENTS

The present invention overcomes the aforementioned disadvantages by providing methods of deacidifying cellulose-based materials that are not only adaptable for use with a wide range of deacidification agents, but also tend to be more environmentally-friendly and less costly than prior art processes.

One important aspect of the present invention is the discovery that hydrofluorocarbons (HFCs) can be used to great advantage in conjunction with a wide variety of basic materials to form compositions suitable for use in deacidifying acidic cellulosic materials. Applicants have determined, for example, that HFCs, preferably HFCs having a boiling point of from about −18.0° C. to about 55° C., and even more preferably from about −18.0° C. to about 50° C., are capable of dispersing sufficient amounts of deacidifying agents therein such that compositions comprising such HFCs and deacidifying agents may be advantageously introduced to acidic materials to reduce the pH associated therewith. As used herein, the term “hydrofluorocarbon” refers to any organic compound having both hydrogen and fluorine substituents but no chlorine substituents.

Moreover, in addition to having desirable dispersion characteristics, the HFC compositions of the present invention are beneficial in that they do not contribute to ozone depletion and are not generally implicated in global warming problems. The present HFCs are also relatively volatile, and thus, can be removed easily from the cellulosic materials without the need to resort to conventional drying methods that often require excessive heat, and/or are otherwise excessively expensive and time-consuming. In addition, unlike prior art deacidifying compositions, preferred compositions of the present method are also relatively inexpensive, and exhibit additional beneficial properties such as, low or no flammability (non-flammability), low toxicity, and low reactivity (inert).

According to certain embodiments, the present invention provides methods of deacidifying cellulose-based materials. Preferably, the methods of the present invention comprise providing a composition comprising a hydrofluorocarbon and a deacidification agent, the deacidification agent being dispersed within the hydrofluorocarbon, and contacting the cellulose-based material with the composition to increase the pH of the cellulose-based material.

According to certain other embodiments, the present invention provides deacidification compositions comprising, preferably consisting essentially of, and even more preferably consisiting of a hydrofluorocarbon and a deacidification agent, the deacidification agent being dispersed within the hydrofluorocarbon.

In view of the teachings contained herein, any of a wide range of hydrofluorocarbons are suitable for use according to the present invention. According to certain preferred embodiments, the hydrocarbons for use in the present invention comprise C2-C5 HFCs, and even more preferably C3-C4 HFCs, having a boiling point of from about −18.0° C. to about 55° C. As used herein, the term C2-C5 HFCs refers to any HFC having from two to five carbon atoms in the backbone, and similarly the term C3-C4 HFC means any HFC having from three to four carbon atoms in the backbone. For example, preferred C3-C4 HFCs include hexafluorobutanes, pentafluorobutanes, hexafluoropropanes, pentafluoropropanes, and combinations of two or more thereof. Examples of hexafluorobutanes, pentafluorobutanes, hexafluoropropanes and pentafluoropropanes suitable for use in the present invention are listed, along with their boiling points, in Table 1. More preferred hydrofluorocarbons include those having a boiling point of from about −18.0° C. to about 50° C., such as, HFC-245fa, HFC-245ca, HFC-245cb, and HFC-245eb. An especially preferred hydrofluorocarbon is HFC-245fa.

TABLE 1

| Compound | Formula | Boiling Point (° C.) |
|---|---|---|
| HFC-245fa | CF₃CH₂CF₂H | 15.3 |
| HFC-245ca | CHF₂CF₂CFH₂ | 25.0 |
| HFC-245cb | CF₃CF₂CH₃ | −18.3 |
| HFC-245eb | CF₃CHFCFH₂ | 22.7 |
| HFC-236ea | CF₃CHFCHF₂ | 6.5 |
| HFC-236fa | CF₃CH₂CF₃ | −1.1 |
| HFC-365mfc | CF₃CH₂CF₂CH₃ | 40 |
| HFC-356mffm | CF₃CH₂CH₂CF₃ | 24.9 |
| HFC-356mfc | CF₃CH₂CF₂CFH₂ | 44 |
| HFC-4310 | CF₃CHFCF₂CHFCF₃ | 54 |

As used herein the term “deacidification agent” refers generally to any basic material that can be used in conjunction with the hydrofluorocarbon fluids of the present invention to deacidify cellulose-based materials. Examples of deacidification agents suitable for use in the present invention include the oxides, hydroxides, carbonates and bicarbonates of zinc and metals in Group I and Group II of the Periodic Table. According to certain embodiments, the deacidification agents of the present invention are preferably oxides, hydroxides, carbonates and bicarbonates of zinc, magnesium, sodium, potassium, calcium, or combinations of two or more thereof. Examples of such preferred agents include zinc carbonate, zinc bicarbonate, zinc oxide, magnesium carbonate, magnesium bicarbonate, magnesium oxide, magnesium methyl carbonate, calcium oxide, sodium hydroxide, potassium hydroxide, calcium hydroxide, and combinations of two or more thereof. More preferred deacidification agents include magnesium oxide and magnesium methyl carbonate. An especially preferred deacidification agent is magnesium oxide.

In certain embodiments, the deacidification agents of the present invention are used in particle form. According to certain preferred embodiments, the deacidification agent particles are of a size suitable for being depositing on a cellulose-based material to cause deacidification of the material without substantially impairing images, if any, thereon. The predominant particle size (i.e. the size of from about 90 to about 99%, and preferably from about 95 to about 99% of the particles) is preferably from about 0.01 to about 1.0 micron. According to certain other preferred embodiments, the predominant particle size is from about 0.2 to about 0.5 micron. The particle surface area is preferably from about 50 to about 200 m²/g BET, more preferably from about 100 to about 200 m²/g, and even more preferably about 170 m²/g.

A variety of deacidification agent particles suitable for use in the present invention are available commercially and/or can be prepared using processes known in the art. As will be recognized by those of skill in the art, processes for preparing alkaline metal particles include burning elemental metals and collecting the resulting smoke, attrition of preformed oxides, calcination of elemental salts, and the like. In light of the disclosure herein, those of skill in the art will readily be able to obtain deacidification agent particles suitable for use in the present invention.

According to certain embodiments, the compositions used in the present invention further comprise a surfactant. Any of a wide range of surfactants are suitable for use in the present invention. Preferably, the surfactants used in the present invention are fluorinated surfactants, such as, for example, Fluorad FC740 (approximately 50% petroleum naptha and 50% fluoroaliphatic polymeric esters) and FC721 available commercially from 3M Corporation, and Solsperse 3000 and 6000 available commercially from ICI Corporation.

Those of skill in the art will recognize that the amounts of deacidification agent, hydrofluorocarbon, and surfactant to be used for any particular application will depend on a number of factors including the length of treatment of the cellulose material with the deacidification composition and the amount of deposition of deacidification agent required. In general, it is desirable that sufficient deacidification agent is used with a given hydrofluorocarbon such that the resulting composition contains a minimum concentration of agent dispersed therein over at least the length of time needed to deposit the agent on cellulosic material. In certain embodiments, the addition of a surfactant may help increase the dispersibility of deacidification agent in the HFC.

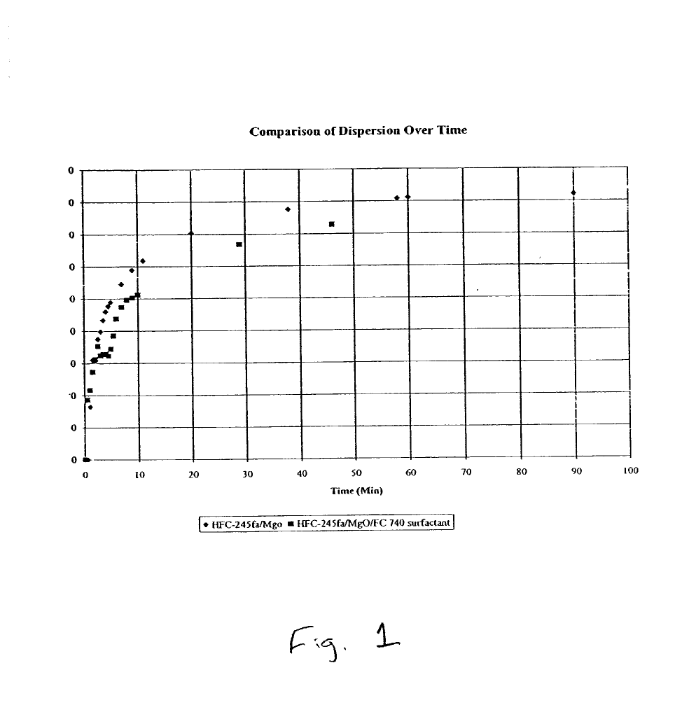

To identify examples of HFC/deacidification agent (and optional surfactant) amounts and combinations for use according to the present invention, applicants conducted turbidity/dispersability studies. The studies were conducted by mixing given amounts of deacidification agents into HFC fluids and measuring the light transmission therethrough, over time, in Nephelometric Turbidity Units (NTUs) via known light transmission experiments. The NTU measurements were used to calculate the amount of deacidification agent that dropped out of the composition mix over time. For example, Table 2 illustrates the turbidity data obtained for a composition (A) of the present invention comprising 500 grams of HFC-245fa and 1.6 grams of magnesium oxide and a composition (B) comprising 500 grams of HFC-245fa, 1.6 grams of magnesium oxide and 0.41 grams of surfactant. These compositions are illustrative of those suitable for use in the present invention, but are not intended to be limiting. The data of Table 2 is shown graphically in FIG. 1.

TABLE 2

| Composition A | | | Composition B | | |
|---|---|---|---|---|---|
| | Turbidity | | | Turbidity | |
| Minutes | (NTU) | % settled | Minutes | (NTU) | % settled |
| — | — | — | 0 | 993 | 0 |
| 0.5 | 1127 | 0 | 0.5 | 808 | 19 |
| 1.0 | 942 | 16 | 1.0 | 778 | 22 |
| 1.5 | 778 | 31 | 1.5 | 722 | 27 |
| 2.0 | 780 | 31 | 2.0 | 683 | 31 |
| 2.5 | 705 | 37 | 2.5 | 643 | 35 |
| 3.0 | 679 | 40 | 3.0 | 672 | 32 |
| 3.5 | 639 | 43 | 3.5 | 667 | 33 |
| 4.0 | 609 | 46 | 4.0 | 667 | 33 |
| 4.5 | 590 | 48 | 4.5 | 673 | 32 |
| 5.0 | 576 | 49 | 5.0 | 651 | 34 |
| 7.0 | 513 | 54 | 5.5 | 611 | 38 |
| 9.0 | 463 | 59 | 6.0 | 559 | 44 |
| 11 | 430 | 62 | 7.0 | 522 | 47 |
| 20 | 335 | 70 | 8.0 | 501 | 50 |
| 38 | 253 | 78 | 9.0 | 494 | 50 |
| 58 | 217 | 81 | 10 | 485 | 51 |
| 60 | 213 | 81 | 29 | 330 | 67 |
| 90 | 202 | 82 | 46 | 270 | 73 |
| 480 | 178 | 84 | 101 | 203 | 80 |

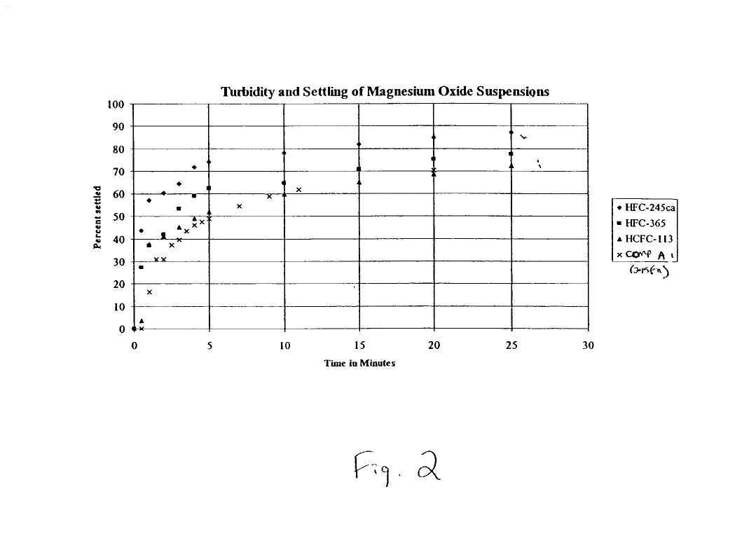

In addition, Table 3 lists the turbidity data for two compositions of the present invention: one comprising 26 cubic centimeters (cc) of HFC-245ca, 0.0816 weight percent of magnesium oxide (based on the total weight of the composition), and 0.04 weight percent FC-740, and the other comprising 26 cc of HFC-365, 0.0816 weight percent magnesium oxide, and 0.04 weight percent FC-740. These compositions are illustrative of those suitable for use in the present invention, but are not intended to be limiting. For comparative purposes, Table 3 also lists turbidity data for a composition comprising 92 cc of HCFC-113, 0.29 weight percent magnesium oxide and 0.14 weight percent of FC-740. FIG. 2 shows graphically the percent settled over time of the three compositions listed in Table 3 and Composition A

TABLE 3

| HFC-245/MgO/FC-740 | | | HFC-365/MgO/FC-740 | | | HCFC-113/MgO/FC-740 | | |
|---|---|---|---|---|---|---|---|---|
| | Turbidity | | | Turbidity | | | Turbidity | |
| Minutes | (NTU) | % settled | Minutes | (NTU) | % settled | Minutes | (NTU) | % settled |
| 0 | 1505 | 0 | 0 | 1623 | 0 | 0 | 1412 | 0 |
| 0.5 | 847 | 44 | 0.5 | 1176 | 28 | 0.5 | 1362 | 4 |
| 1 | 646 | 57 | 1 | 1024 | 37 | 1 | 881 | 38 |
| 2 | 597 | 60 | 2 | 942 | 42 | 2 | 832 | 41 |
| 3 | 537 | 64 | 3 | 756 | 53 | 3 | 775 | 45 |
| 4 | 426 | 72 | 4 | 665 | 59 | 4 | 720 | 49 |
| 5 | 390 | 74 | 5 | 612 | 62 | 5 | 681 | 52 |
| 10 | 327 | 78 | 10 | 574 | 65 | 10 | 567 | 60 |
| 15 | 272 | 82 | 15 | 475 | 71 | 15 | 496 | 65 |
| 20 | 228 | 85 | 20 | 402 | 75 | 20 | 446 | 68 |
| 25 | 195 | 87 | 25 | 363 | 78 | 25 | 392 | 72 |

According to certain embodiments, the concentration of the deacidification agent in the composition is preferably from about 0.001 to about 0.5 weight percent based on the total weight of the compositions. According to certain more preferred embodiments, the deacidification agent concentration if from about 0.01 to about 0.3 weight percent.

According to certain preferred embodiments, the surfactant has a concentration of from about 0.005 to about 1.0 weight percent based on the total weight of the deacidifying composition. More preferably the concentration is from about 0.005 and 0.5 weight percent.

In light of the disclosure contained herein those of skill in the art will readily be able to formulate HFC/deacidification agent compositions suitable for use in a wide range of applications of the present invention.

The contacting step of the present invention involves contacting at least a portion of a cellulose-based material with a composition of the present invention to increase the pH associated with the cellulose material. Any of a wide range of cellulose-based materials can be used in the present methods. For example, suitable materials include paper and paper products, books, wood and wood products, combinations of two or more thereof, and the like.

Any of a wide range of methods for contacting the acidic cellulose material with a composition of the present invention can be used. Examples of suitable contacting methods include immersion of the cellulose material in the composition, adding the composition dropwise to the cellulose material, spraying the composition onto the cellulose material, combinations of two or more thereof, and the like. Optionally, the use of electrostatic attraction may be used in conjunction with the above methods to enhance deposit of materials on paper. According to certain preferred embodiments, the step of contacting the cellulose material involves contacting substantially the entire surface area of the cellulose material with the composition such that removal of the composition results in lowering the acidity of the cellulose material.

The contacting step of the present invention may further comprise the step of removing the HFC from the cellulosic material to deposit at least a portion of the deacidification agent on the cellulosic material. Any known methods for removing the HFC may be used according to the present invention. Preferably, the removing step comprises evaporating the HFC from the cellulosic material. According to certain embodiments, the evaporating step comprises changing the pressure and/or temperature to which the HFC and cellulosic material are exposed such that the HFC is converted to the gaseous state.

Once a cellulose material has been deacidified according to the present invention, the removed HFC solvent can be recycled for further use. In this manner, the present invention allows for the deacidification of cellulosic materials without the need for time-consuming solvent-removing drying steps and excess clean-up.

### EXAMPLES

The present invention is further illustrated by the following examples. Such examples do not in any way restrict the effective scope of the invention.

### Example 1

This example illustrates a preferred method of deacidifying paper according to the present invention.

One thousand (1000) grams of HFC-245fa are mixed with 3.2 grams of magnesium oxide and 0.8 grams of surfactant FC-740. The mixture is placed in a 2 liter beaker and stirred. A cooling coil is placed on the lip of the beaker to condense and recirculate HFC-245fa vapor. Four samples of 63 year old paper are prepared and the acidity of each sample is measured using the TAPPI509 om-96 method, a copy of a document describing this method is attached hereto and is incorporated herein by reference. The pH measurement of each sample is 4.6±0.02. Each sample is dipped in the mixture in the beaker for twenty seconds and allowed to dry for 5 minutes. The pH of each sample is then measured. The average pH of the four samples is 8.9±0.4.

### Example 2

This example illustrates another preferred method of deacidifying paper according to the present invention.

An 150 cc aerosol can is loaded with 50 grams of a suspension prepared according to Example 1. HFC-134a (1.5 grams) is added to the can to act as a propellant for the suspension. A sample of 63 year old paper as described in Example 1 is sprayed with the suspension from the aerosol can. The pH of the paper after spraying is measured to be 9.0.

### Example 3

This example illustrates the dispersion characteristics of preferred compositions according to the present invention.

Two compositions (A and B) were prepared according to the present invention. Composition A was prepared by mixing 500 grams of HFC-245fa with 1.6 grams of magnesium oxide. Composition B was prepared by mixing 500 grams of HFC-245fa with 1.6 grams of magnesium oxide and 0.41 grams of surfactant.

The compositions were shaken and the turbidity of the solution is measured over time using a light transmission method. In general, the turbidity is measured in Nephelometric Turbidity Units (NTU). As the NTU value drops, more light is transmitted through the sample, indicating that more of the dispersed phase has settled out of the dispersion. The % loss of magnesium oxide out of the dispersion over time is calculated from the turbidity data. The results are listed in Table 2 and shown graphically in FIG. 1.

What is claimed is:

1. A method of deacidifying a cellulose-based material comprising:
providing a composition comprising a hydrofluorocarbon (HFC) having a boiling point of from about −18.5° C. to about 55° C. and a deacidification agent dispersed in said HFC; and
increasing the pH of said cellulose-based material by contacting said material with said composition.

2. The method of claim 1 wherein said hydrofluorocarbon is a C2- C5 HFC.

3. The method of claim 1 wherein said hydrofluorocarbon has a boiling point of from about −18.5° C. to about 50° C.

4. The method of claim 1 wherein said hydrofluorocarbon is selected from the group consisting of pentafluoropropanes, pentafluorobutanes, hexafluorobutanes, and combinations of two or more thereof.

5. The method of claim 3 wherein said hydrofluorocarbon is selected from the group consisting of HFC-245fa, HFC-245ca, HFC-245cb, HFC-236ea, HFC-236fa, HFC-365mfc, HFC-356mffm, HFC-356mfc, and mixtures of two or more thereof.

6. The method of claim 5 wherein said hydrofluorocarbon is HFC-245fa.

7. The method of claim 1 wherein said deacidification agent is in particle form.

8. The method of claim 7 wherein said deacidification agent particles have a predominant particle size of from about 0.01 to about 1.0 micron.

9. The method of claim 8 wherein said deacidification agent is selected from the group consisting of metal oxides, metal hydroxides, metal carbonates, metal salts, and combinations of two or more thereof.

10. The method of claim 9 wherein said deacidification agent is selected from the group consisting of oxides, hydroxides, carbonates, and combinations of two or more thereof, of Group IA or Group IIA metals.

11. The method of claim 10 wherein said deacidification agent is magnesium oxide.

12. The method of claim 1 wherein said composition further comprises a surfactant.

13. The method of claim 12 wherein said surfactant is a fluorinated surfactant.

14. The method of claim 1 wherein said contacting step comprises immersing at least a portion of said cellulose-based material in said composition.

15. The method of claim 1 wherein said contacting step comprises spraying said composition onto said cellulose-based material.

16. The method of claim 1 wherein said increasing step further comprises evaporating the hydrofluorocarbon from said material subsequent to said contacting step to deposit at least a portion of said deacidifying agent on said cellulose-based material.

17. A deacidification composition comprising a C2-C5 HFC having a boiling point of from about −18.5° C. to about 50° C. and a deacidification agent dispersed in said HFC.

18. The composition of claim 17 wherein said wherein said HFC is a C3-C5 HFC.

19. The composition of claim 17 wherein said hydrofluorocarbon is selected from the group consisting of pentafluoropropanes, pentafluorobutanes, hexafluorobutanes, and combinations of two or more thereof.

20. The composition of claim 18 wherein said hydrofluorocarbon is selected from the group consisting of HFC-245fa, HFC-245ca, HFC-245cb, HFC-236ea, HFC-236fa, HFC-365mfc, HFC-356mffm, HFC-356mfc, and mixtures of two or more thereof.

21. The composition of claim 20 wherein said hydrofluorocarbon comprises HFC-245fa.

22. The composition of claim 21 wherein said deacidification agent is selected from the group consisting of metal oxides, metal hydroxides, metal carbonates, metal salts, and combinations of two or more thereof.

23. The composition of claim 22 wherein said deacidification agent is selected from the group consisting of oxides, hydroxides, carbonates, and combinations of two or more thereof, of Group IA or Group IIA metals.

24. The composition of claim 23 wherein said deacidification agent comprises magnesium oxide.

25. The composition of claim 17 wherein said composition further comprises a surfactant.

26. The composition of claim 27 wherein said surfactant is a fluorinated surfactant.
